(19) United States
(12) Patent Application Publication
(10) Pub. No.: US 2024/0211884 A1
(43) Pub. Date: Jun. 27, 2024

(54) ISSUE TRACKING SYSTEM

(71) Applicants: Atlassian Pty Ltd., Sydney (AU); Atlassian US, Inc., San Francisco, CA (US)

(72) Inventors: Lukas Maczejka, Vienna (AT); Andrii Sokolov, Den Haag (NL); Paul Glantschnig, Bisamberg (AT); Martin Sturm, Eichgraben (AT); Tanguy Bernard Paul Crusson, Nice (FR)

(21) Appl. No.: 18/128,307

(22) Filed: Mar. 30, 2023

(30) Foreign Application Priority Data
Dec. 22, 2022 (AU) 2022903979

(51) Int. Cl. G06Q 10/10; G06Q 10/0633

(52) U.S. Cl. CPC G06Q 10/103; G06Q 10/0633

(57) ABSTRACT

An issue tracking system and a method performed at an issue tracking system is disclosed. Data entities define a plurality of issues in the issue tracking system. These include data defining the issue type within the issue tracking system. An identifier of a second computer processing system and material accessible by the second computer processing system is included in an issue of the issue tracking system. The material accessible by the second computer processing system may be linked to and retrieved using the identifier. The issue may be changed to a second issue type associated with a project workflow, while maintaining the identifier of the second computer processing system and material accessible by the second computer processing system. The material may also be associated with a metric and the metric provided in a field for an issue in the issue tracking system.

### CROSS-REFERENCE TO RELATED APPLICATION(S)

This application claims the benefit of Australian patent application no. AU 2022903979, filed Dec. 22, 2022 and titled “Issue Tracking System,” the disclosure of which is hereby incorporated herein by reference in its entirety.

### TECHNICAL FIELD

The present disclosure is directed to an issue tracking system. Embodiments of the disclosure relate to one or more of functions of an issue tracking system, data structures of an issue tracking system and user interfaces of an issue tracking system.

### BACKGROUND

Product development and management is often a key role within an organisation. Reflecting this, various product development management software applications have been developed, which provide to product managers and product developers useful data collection and analysis tools, as well as useful graphical user interfaces. Examples include applications providing analytics systems, support systems, user survey and feedback systems and project management systems.

The number of sources of data and volume of data available to product managers has rapidly and largely increased. Mining and managing the data in a way that enables it to be used, as well as the effective use of the data, has therefore become an increasingly challenging problem, one that has been addressed to varying degrees by existing software applications.

Background information described in this specification is background information known to the inventors. Reference to this information as background information is not an acknowledgment or suggestion that this background information is prior art or is common general knowledge to a person of ordinary skill in the art.

### SUMMARY

Embodiments of a method performed at an issue tracking system include maintaining, in data storage readable by a first computer processing system, data entities defining a plurality of issues for an issue tracking system, comprising at least one first data entity defining information for a first issue and at least one second data entity defining information for a second issue, different to the first issue.

In some embodiments, the method includes:
maintaining, in data storage readable by a first computer processing system implementing an issue tracking system, data entities defining a plurality of issues for the issue tracking system, comprising at least one first data entity defining information for a first issue and at least one second data entity defining information for a second issue, different to the first issue;
receiving, by the first computer processing system, link request information for material accessible by a second computer processing system, different to the first computer processing system, the link request information comprising at least one identifier, the at least one identifier identifying the second computer processing system and the material;
updating, by the first computer processing system, the at least one first data entity with the at least one identifier;
after the updating, receiving by the first computer processing system a request to display a graphical user interface for the first issue and in response to the request displaying the graphical user interface for the first issue, wherein the graphical user interface includes display of at least one of the material and information based on the material.

In some embodiments the received link request information is received from a second computer processing system, different to the first computer processing system. In some embodiments the second computer processing is providing a web browser and the received link request information comprises a link to a network address displayed by the web browser.

In other embodiments the second computer processing is providing an application for aggregating data, the received link request information comprises a link to the application and the material is data aggregated by the application. The at least one identifier may include a plurality of identifiers, including a first identifier associated with the material and a second identifier associated with different material and wherein the link request information further comprises a user selection, the user selection designating the first identifier. The plurality of identifiers may be received by the first computer processing system responsive to a request from the first computer processing system for available link information, in accordance with an application programing interface of the application for aggregating data.

In some embodiments the first data entity and the second data entity are associated with a project and include a plurality of fields and wherein the updating of the at least one first data entity with the at least one identifier comprises including the at least one identifier in a field of the first data entity and not in a field of the second data entity.

In some embodiments the first data entity and the second data entity are associated with a project and include a plurality of fields and wherein the updating of the at least one first data entity with the at least one identifier comprises including the link to a network address in a field of the first data entity and not in a field of the second data entity. The method may further include including the material in a field of the first data entity and not in a field of the second data entity.

In some embodiments the received link request information does not include the material and wherein the method further comprises, responsive to the request to display the graphical user interface for the first issue, sending by the first computer processing system to the second processing system, a request for the material, wherein the request for the material is generated based on the at least one identifier identifying the second computer processing system and the material.

In some embodiments the method further includes after the updating, receiving a user request and in response to the user request creating in the data storage at least one third data entity defining a third issue of the issue tracking system, wherein the third issue is of a different type to the first issue. The method may further include receiving a request to display the third issue and in response to the request displaying the third issue together with the material.

In some embodiment the method includes, after the updating, receiving a user request and in response to the user request creating in the data storage at least one third data entity defining a third issue of the issue tracking system, wherein the third issue is associated with a project workflow of the issue tracking system and the first issue is not associated with the project workflow. The method may further include receiving a request to display the third issue and in response to the request displaying the third issue together with the material.

In some embodiments the method includes:
maintaining, in data storage readable by a first computer processing system implementing an issue tracking system, data entities defining a plurality of issues for the issue tracking system, comprising at least one first data entity defining information for a first issue and at least one second data entity defining information for a second issue, different to the first issue;
receiving, by the first computer processing system, link request information for material accessible by a second computer processing system, different to the first computer processing system, the link request information comprising the material;
updating, by the first computer processing system, the at least one first data entity with the material;
after the updating, receiving by the first computer processing system a request to display a graphical user interface for the first issue and in response to the request displaying the graphical user interface for the first issue, wherein the graphical user interface includes display of at least one of the material and information based on the material.

In some embodiments the link request information is generated by a third computer processing system, the third computer processing running a web browser, the web browser including an extension or plug-in that generates the link request information and communicates it to the first computer processing system.

In some embodiments the method further includes, after the updating, receiving a user request and in response to the user request creating in the data storage at least one third data entity defining a third issue of the issue tracking system, wherein the third issue is of a different type to the first issue. The method may further include receiving a request to display the third issue and in response to the request displaying the third issue together with the material.

In some embodiments the method further includes, after the updating, receiving a user request and in response to the user request creating in the data storage at least one third data entity defining a third issue of the issue tracking system, wherein the third issue is associated with a project workflow of the issue tracking system and the first issue is not associated with the project workflow. The method may further include receiving a request to display the third issue and in response to the request displaying the third issue together with the material.

Embodiments of an issue tracking system include a computer processing system configured to perform any method described herein or any part thereof.

Embodiments of non-transient computer readable storage include instructions to cause a computer processing system to perform any method described herein any part thereof.

### BRIEF DESCRIPTION OF THE DRAWINGS

FIG. 1 is a diagram depicting a networked environment in which various features of the present disclosure may be implemented.

FIG. 2 is a data flow diagram of example data communications between computer processing systems, for example the systems depicted in FIG. 1.

FIGS. 3A to 8 are example issue display screens of an issue tracking system, for example as described with reference to FIG. 1.

FIGS. 9 and 10 are representations of example data entities for an issue tracking system, for example as described with reference to FIG. 1.

FIGS. 11A and 11B show a flow diagram of an example method performed at an issue tracing system, for example as described with reference to FIG. 1.

FIG. 12 is a block diagram of a computer processing system configurable to perform various features of the present disclosure.

FIG. 13 is an example timeline display screen of an issue tracking system.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION

In the following description numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

The following description is made with specific reference to an example embodiment of functionality added to or included in, or which interacts with an issue tracking system in the form of a project management system. The project management system may include project management functionality, for example a project management application or module(s), providing a range of functions, including for example one or more of functions to identify the workflow of and track the progress of a plurality of issues, functions to allocate people and other resources to issues, functions to allocate issues to projects, and functions to identify a roadmap for a product based on the projects and/or issues relating to the product. An example of a project management system for project management teams is the family of products generally called Jira Software™, available from Atlassian, Inc or Atlassian Pty Ltd.

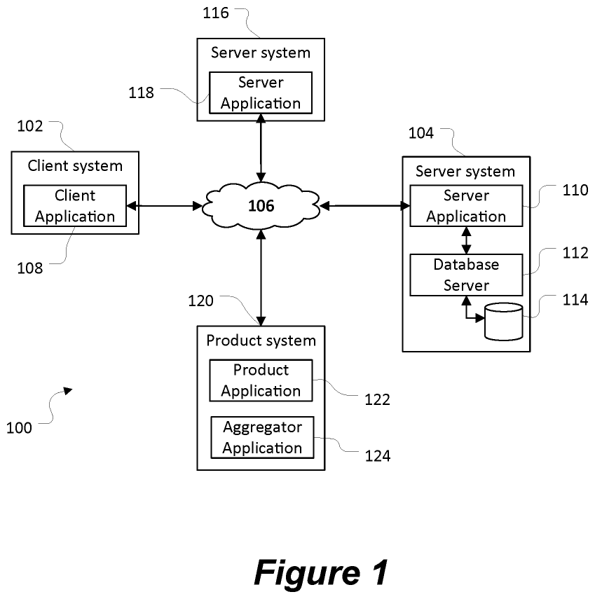

FIG. 1 depicts one example of a networked environment 100 in which the various operations and techniques described herein can be performed.

Networked environment 100 includes a client system 102 and a project management system 104, which communicate via one or more communications networks 106 (e.g., the Internet).

The client system 102 hosts a client application 108 which, when executed by the client system 102, configures the client system 108 to provide client-side functionality/interact with sever system 104 or, more specifically, project management application 110 running thereon.

The client application 108 may be a general web browser application (such as Chrome, Safari, Internet Explorer, Opera, or an alternative web browser application), which accesses the project management application 110 via an appropriate uniform resource locator (URL) and communicates with the project management application 110 via general world-wide-web protocols (e.g., http, https, ftp). Alternatively, the client application 108 may be a specific application programmed to communicate with project management application 110 using defined application programming interface (API) calls.

A given client system 102 may have more than one client application 108, for example both a general web browser application and a dedicated programmatic client application.

Project management system 104 is a server system that hosts a project management application 110. The server application is executed by the project management system 104 to configure it to provide server-side functionality to one or more corresponding client applications, including for example one or more client applications 108 as discussed above. The project management application 110 comprises one or more application programs, routines, libraries, APIs, or other software elements that implement the features and functions that are described herein. For example, where the client application 108 is a web browser, the project management system 104 will include a web server. Where the client application 108 is a specific application, the project management system 110 will include an application server configured specifically to interact with that client application 108. Project management system 104 may be provided with both web server and application server modules.

In the present example project management system 104 also includes a database server 112. Database server 112 provide access to data storage, in particular one or more databases 114 which store data relevant to the services being offered by the server.

The client system 102 and project management system 104 communicate data between each other either directly or indirectly through one or more communications networks 106. Communications network 106 may comprise a local area network (LAN), a public network, or a combination of networks. In some embodiments the communication network 106 is the Internet and such the project management system 104 can access any internet-accessible location, including for example webpages of websites.

While the project management system 104 of the environment 100 is depicted and described as a single server machine, alternative architectures are possible. For example, in certain cases a clustered server architecture may be used where multiple server computing instances (or nodes) are instantiated on one or more computer processing systems to meet system demand. Conversely, in the case of small enterprises with relatively simple requirements, the project management system 104 may be a stand-alone implementation (e.g., a single computer directly accessed/used by end users). Project management system 104 has been illustrated as a single system. Project management system 104 can, however, be a scalable server system comprising multiple nodes which can be commissioned/decommissioned based on processing requirements.

The client system 102 may be any computer processing system which is configured (or configurable) by hardware and/or software to offer client-side functionality. Similarly, the project management system 104 may be any computer processing system which is configured (or configurable) by hardware and/or software to provide server-side functionality. By way of example, suitable client and/or server systems may include server computer systems, desktop computers, laptop computers, netbook computers, tablet computing devices, mobile/smart phones, personal digital assistants, personal media players, set-top boxes, games consoles.

The networked environment 100 also includes a data aggregator system 116, which is also a server system, and which communicates with at least the project management system 104 via the one or more communications networks 106. The data aggregator system 116 includes an aggregator application 118 for collecting data.

In some embodiments the aggregator application 118 comprises an analytics engine. The analytics engine collects data on the use of at least one product feature. The product may be a software product. For example, the analytics engine may collect data on the frequency of use of a feature or function provided by software, across users of the software. The software may be provided by a product application 122 hosted on a product system 120, which is also a server system. The users of the product application 122 may be users of the client system 102, for example via the client application 108 if it is a general application like a browser or via a specific client application for the product application 122. An aggregator application 124 may be installed on the product system 120 to collect use data of one or more features of the product application 122. The product system 120 may communicate the use data to the data aggregator system 116 via the one or more communications networks 106 on demand and/or at intervals based on time, volume of interactions, or in real time, or otherwise.

In some embodiments the aggregator application 118 comprises a survey application and/or a feedback application, configured to provide results of a survey of users of a product or feedback of users of a product respectively, for example and in particular users of the product application 122. A user may enter the survey or feedback data using the client system 102.

In some embodiments the data aggregator system 116 collects a plurality of forms of data for the same product. For example, the data aggregator system 116 provides two or more of: an analytics engine, a survey application, and a feedback application. In some embodiments the networked environment includes a plurality of aggregator system 116 collecting different data. For example, one aggregator system 116 may include an analytics engine and another aggregator system 116 may include a survey application and another aggregator system 116 may include a feedback application.

Whilst FIG. 1 shows only a single client system 102, in a practical system there will be more than one client system. Each of the client systems may have the same or different client applications installed. Often, the users of the project management system 104, the data aggregator system 116 and the product system 120 (each of which will typically have a plurality of users, in some cases a large number of users) will be different and the different users will each operate a different client system 102. Similarly other components shown in FIG. 1 may be duplicated, potentially many times.

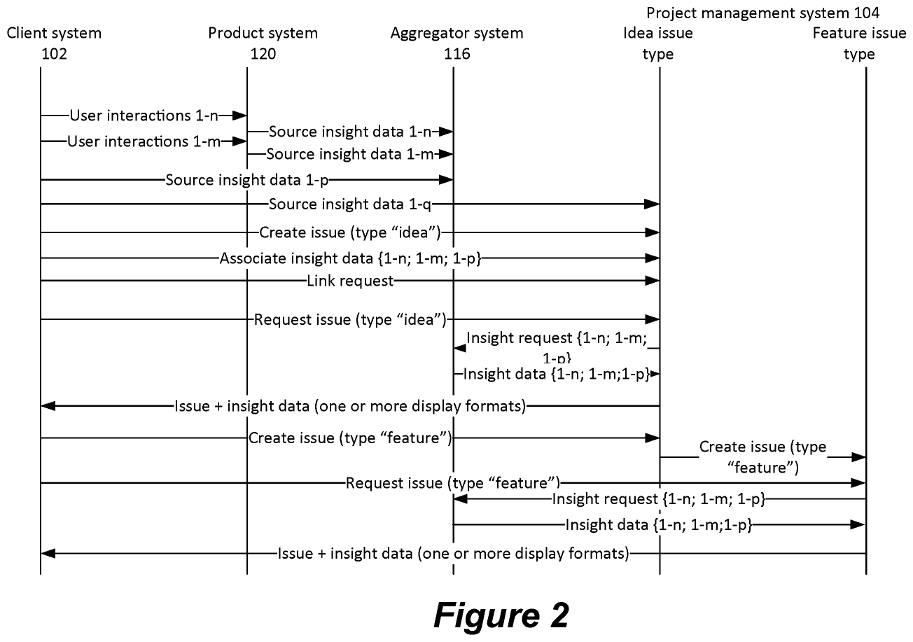

FIG. 2 shows a data flow diagram of example communications between the client system 102, project management system 104, data aggregator system 116 and product system 120 described with reference to FIG. 1. For clarity of illustration only a single column is provided for each system in each category. It will be appreciated that each system may comprise one or a plurality of computer processing devices. For example, and in particular, communications from the client system 102 may be from a plurality of distinct computer processing devices, each forming a respective client system 102 and each operated by a separate user. In another example, one data aggregator system may provide an analytics engine and a different data aggregator system may provide a survey and/or feedback system, both of which may communicate with the project management system 104. It will also be appreciated that a plurality of substantially independent systems depicted in FIG. 2 may communicate with a single other system instance. For example, there may be a plurality of product systems 120, each substantially independently offering respective product applications, which communicate with a single data aggregator system 116. The single data aggregator system 116 may communicate with a single project management system 104 or a plurality of project management systems 104.

In some embodiments, the product system 120 provides a software as a service (SaaS) application (product application 122 of FIG. 1) to a plurality of customers. Each customer has a plurality of users. For example, a first customer has n active users of the product system 120 and a second customer has m active users of the product system 120. The active users interact with the product system 120.

In embodiments including an analytics engine, the aggregator system 116 collects data, called “source insight data” in FIG. 2, relating to the interactions. The product system 120 communicates the source insight data to the data aggregator system 116. An example of source insight data is the number of times a product feature is used, which may be measured for example by the number of user selections or “clicks” that the product feature is invoked in response to. In that case, the insight source data for one user may include a count of clicks invoking the product feature over a certain time period, for example a day or a week and/or may include a rate of clicks per unit time period. Other measures unrelated to time may be used, for example the proportion of users that use the product feature, the number of users of a product, the number of customers of a product or the number of visitors to a web site of set of web sites or other identifying network location(s).

A function of the analytics engine may include aggregating user data across customers. Taking the example of insight data in the form of the number of times a product feature is used, then a function of the analytics engine is to combine the instances of use across the first and second customers, or in other words combine the source insight data 1-n with the source insight data 1-m, to produce insight data {1-n; 1-m}. It will be appreciated that the combination may be across more than two customers, potentially many customers. It will also be appreciated that the division of insight data need not be by customer, but by another characteristic, for example category of user independent of which customer the user is a member of.

In embodiments including a survey or user feedback system, the data aggregator system 116 may receive user interactions, in particular responses to survey questions or user feedback, from a client system 102 operated by the users. In that case the user interactions of p users responding to the survey or providing the feedback creates the source insight data 1-p. The aggregator application 118 can collect the interactions and categorise them, for example based on the product feature or features that the question and/or response and/or feedback relates to, to thereby by produce source insight data {1-p}.

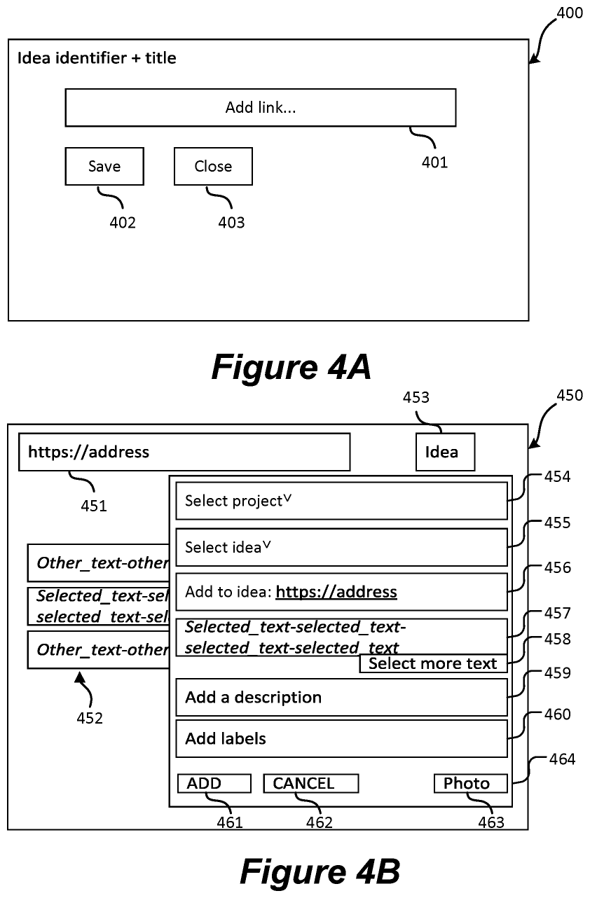

In some embodiments additional source insight data can be provided directly to the project management system 104. A user may operate a client system 102 to identify, enter or generate q instances of source insight data, creating source insight data {1-q}. An example of the direct provision of source insight data is the entry of text or images or identification of text or from a network (e.g., internet) location. Example user interfaces for this function are described herein with reference to FIGS. 4A and 4B.

In some embodiments, the data aggregator system 116 will include further interactions with client systems 102, through which users can configure the data aggregation service (e.g., configure the analytics engine or survey) and view the results from the analytics engine or survey. These additional services may operate substantially independently of the project management system 104 and are outside the scope of the present disclosure.

The project management system 104 is depicted in two functional parts in FIG. 2. A first part referenced relates to functionality to manage, amongst other things, insight data in relation to an idea issue type and a second part relates to functionality to manage project data in relation to a feature issue type (see herein below for a description of the issue types). In some embodiments the functionality is provided by the same project management application 110 and the following description of FIG. 2 is in relation to this embodiment. This enables various advantages, including a common data format across the two functions, leading to an ability to consistently handle and present functions of the project management system 104 across both functions. As described herein, the project management system 104 may therefore be used to provide effective mechanisms by which product managers can have visibility over a product, ranging from insight data through to development project work. In other embodiments separate applications provide the insight data management functions and the project data management functions and these communicate via an appropriate application programming interface (API). It will also be understood that in some embodiments one or other of the functional parts may be implemented without the other.

A client system 102 communicates to the project management system 104 a request to create a data entity, called an “issue” herein. The issue has a type, designated within the data entity, for example by a field containing the issue type designation. The type indicates that the issue is related to tasks for managing insight data. For the purposes of illustration, the issue type for the requested data entity may be “idea,” reflecting that the insight data may be used to evaluate ideas for potential development projects for a product. The idea issue type may also be related to tasks other than managing insight data. The request includes a designation of the requested issue type. In some embodiments the request is generated by the client system 102 responsive to a user operating the client system 102, in particular user interface of the client application 108, which includes a field for entering the issue type and/or a selector for selecting the issue type from the available issue types. The project management system 104 stores the data entity for the issue in the database 114. Referring to the example arrangement in FIG. 1, the server application 110 receives the request to create a data entity, creates the data entity and communicates the data defining the data entity to the database server 112, for storage in the database 114. The project management system 104 stores the data entity for the issue associated with a project. The project is defined in the project management system 104 through prior user interactions with the project management system 104. For example, user may have set up project for development of a product or a feature of the product. Accordingly, when a user operates the project management system 104 so as to create an issue of the type “idea”, they are indicating that they consider the issue to be related to project, for example related to a product or product feature that the project encompasses. A single project may have a plurality of issues associated with it, including one or more issues of the type “idea” and one or more other issues of different issue types.

In some embodiments the issue type “idea” has one of a plurality of available statuses for that type. The statuses may be related to a workflow for the issue type, or alternatively the issue type “idea” may not be associated with a workflow. The workflow may be configured by users of the project management system 104, reflecting their process for managing the evaluation of ideas. People and/or other resources may also be allocated and updated based on the status and the status may transition based on user interactions with the project management system 104.

A client system 102 also communicates to the project management system 104 a request to associate insight data with the created issue. The request to associate insight data includes an identifier of the insight data to be associated with the issue. In one example, the identifier is in the form of a network address for the insight data. The network address will point to the data aggregator system 116 and identify to the data aggregator system particular insight data that it is managing or storing. In another example the identifier may include a first identifier that identifies the aggregator system 116 and a second identifier generated or provided by the aggregator system to identify particular insight data, which may have been generated or provided responsive to a user request to the aggregator system 116. The network address, communication channel and/or other data determining the communication between the project management system 104 and the data aggregator system 116 may then be stored by the project management system associated with the first identifier and the communication from the project management system 104 to the data aggregator system 116 (see below) may include the second identifier. It will be appreciated that by providing identifiers of the insight data, rather than the insight data itself, the system accommodates updates to the insight data over time. In some embodiments the request to associate insight data is communicated together with or be implicit with the communication of insight data, as may occur for example for insight data {1-q}.

The request to associate insight data with the created issue may be from the same client system that communicated the request to create the issue, operated by the same or a different user, or from another client system (again operated by the same or a different user). The request to associate insight data with the created issue may be made as part of a request to create the issue, for example as a variable to complete as part of an issue creation process or at a later time after the issue has been created, for example as a variable of an issue that can be edited. The project management system 104 may be configured to provide one or both of these options.

The insight data may represent or form the basis for a graphical output of the aggregator system 116. For example, a graphical output representing insight data {1-n; 1-m} of use of product feature over time, may be in the form of a graph or plot with time as the independent variable (typically horizontal axis) and number of product feature uses as the dependent variable (typically vertical axis). In another example, the insight data may include text or be text-based, for example insight data {1-p} may be a collection of comments about the product feature received by the data aggregator system 116 as part of source insight data 1-p, or insight data {1-p} may be text. In a still further example, any of the insight data may include image data. In some embodiments a single issue can be associated with a plurality of different insight data sources, for example two or more sets of analytics data relating to product feature or one set of analytics data and one set of feedback data relating to the product feature. The association may be via a single communication (e.g., as shown in FIG. 2 in which a single request is sent to associate both insight data {1-n; 1-m} and insight data {1-p}) or by two or more communications, for example one communication per association request (e.g., for insight data {1-q}).

In some embodiments the project management system 104 includes and provides to a user a function to link insight data to a field of the issue and/or a function to link insight data to a field associated with the issue. An example of an associated field is a field of a data entity separate to the issue but referenced by a field in the issue. To form the link, a link request is communicated from a client system 102 to the project management system 104. The link request is in relation to or identifies the insight data to be linked. For example, insight data associated with an issue may be displayed at a client system 102 in a user interface that includes a function to select the insight data. Following or responsive to selection of the insight data, the user interface may display a selector for selecting a field of the issue. The fields suitable for linking with insight data are predefined in the project management system 104. Accordingly, in one example the selector may be a menu of selectable fields. By linking the insight data to an issue field, the project management 104 can display one or more of the insight data, information based on the insight data or a user operable link to access the insight data in an integrated manner with the display of the issue, as part of project management service delivery. In some embodiments the issue field is dynamic, populated with data that is updated as required based on one or more characteristics of the linked insight data, which may change over time.

In some embodiments the link between insight data and a field of the issue is between a metric of the insight data and the field. For example, an analytics engine may maintain a count of a variable that it is monitoring. In another example a survey or feedback system may provide a count of votes on an issue or a count of number instances that a product feature is referred to. In some embodiments the link between the insight data a field of the issue is a many-to-one relationship. For example, two different sets of insight data, each with a metric, may be linked to the same field. Both metrics may be individually linked to the field, or a single combined metric determined and stored in the field. The project management system 104 may be configured to receive from a client system 102 data reflecting user input indicating of the weighting to provide to each metric in determining or calculating a combined metric.

The project management system 104 is configured to retrieve the insight data associated with an issue from one or more data aggregator systems 116 and cause the insight data to be provided to the project management system 104, which may for example present the insight data or other information based on the insight data on a display of the client system 102 of the user. In some embodiments, retrieval of insight data from the aggregator system 116 is responsive to a request to display content of the issue. In this way, the insight data may be updated over time by the data aggregator system 16 without being communicated to the project management system 101 and only communicated when it is required.

For example, for an issue associated with insight data {1-n; 1-m} and insight data {1-p}, in response to the request to display content for the issue or a metric for the issue based on the insight data the project management system may send request for the associated insight data {1-n; 1-m} and insight data {1-p} to the one or more aggregator systems 116 identified as part of the association. While a single communication is shown in FIG. 2 for the insight data {1-n; 1-m; 1-p}, in other embodiments there may be a plurality of communications, for example one for insight data {1-n; 1-m} and one for insight data {1-p}. The one or more data aggregator systems 116 return, and the project management system 104 receives, the insight data {1-n; 1-m; 1-p} in one or more communications.

The request to display content of the issue may be specific to the insight data. For example, the request may be generated responsive to a user selecting a button, link or other user interface element that is directly associated with the insight data. The request to display content of the issue may be a general request, for example to display an issue with the system configured to display various characteristics of the issue, one or more of which is insight data or based on insight data. The insight data may be displayed in one region of the user interface and other data of the issue may be displayed in another region of the user interface. In another example the project management system may also retrieve insight data associated with an issue responsive to a request to display a metric that is determined by the project management system 104 based on the insight data. The metric may be displayed without displaying the insight data on which it is based. In another example the project management system may also retrieve insight data associated with an issue responsive to a request to display a field linked to the insight data.

In some embodiments the project management system 104 is configured with functionality to transfer an idea issue type into another issue type or link the idea issue type with another issue type. For example, the transfer or link functionality may include creating a new issue with a “feature” issue type. The feature issue type may be associated with different workflows and/or statuses in comparison to the idea issue type. For example, the workflow and statuses of the feature issue type may reflect a process for developing new software functionality. This may be contrasted to workflows and/or statuses adapted for evaluating an idea, for instance to facilitate a decision as to whether software functionality for the idea should be developed. In some embodiments the new feature issue has the same identifier within the project management system 104 as the idea issue, with the transfer being an update to a field indicating the issue type. A version number field or similar may be updated with the transfer. In some embodiments the feature issue includes a flag, field, or other indicator that it was based on an idea issue, allowing tracking of ideas that have been transferred to feature issues. In other embodiments, a new issue is created for the feature issue, with a unique identifier different to the idea issue. If a new issue is created, then a field of the feature issue may include an identifier of the idea issue, showing the linkage between the two issues.

The project management system 104 may automatically populate fields of the feature issue type with information from fields of an idea issue type. For example, the field or fields containing references to insight data, as described above, may be automatically populated in the feature issue type based on the content of the corresponding fields in the idea issue type (e.g., by copying the field content or by linking to the field content). In another example, the fields containing or defining a metric based on the insight data may be automatically populated in the feature issue type based on the idea issue type.

Accordingly, when a client system 102 makes a request, to the project management system 104, for an issue of feature issue type that was created based on an idea issue type, the project management system 104 requests insight data from the data aggregator system 116. The data aggregator system 116 returns the insight data, which is then caused by the project management system 104 to be displayed by the client system 102. Similarly, metrics or other information based on the returned insight data may be displayed by the client system 102 within or in association with the feature issue type. This process may be substantially the same as the previously described process for retrieving insight data for the idea issue type.

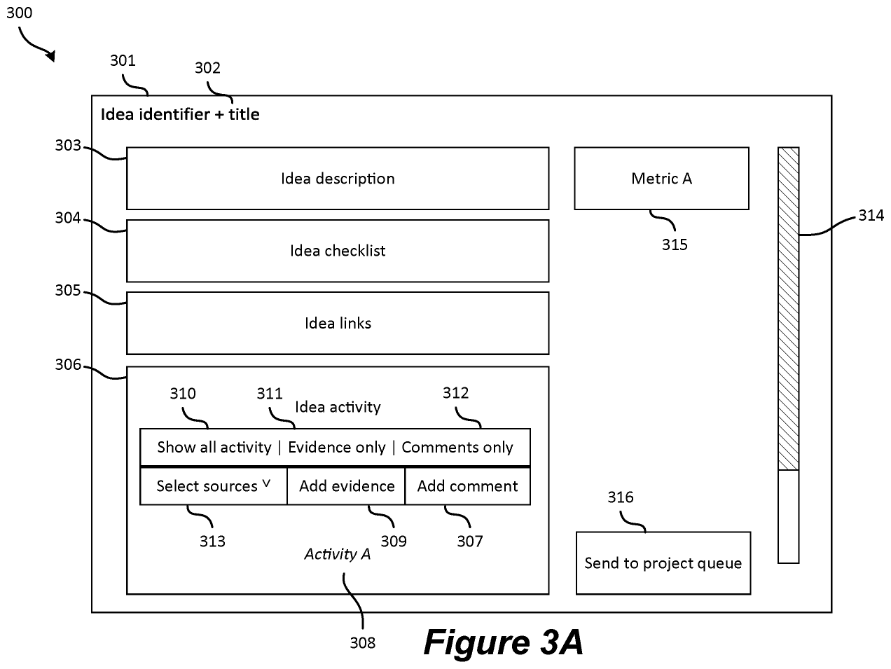

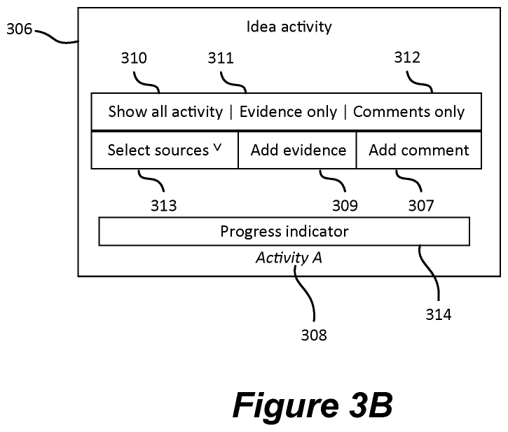

FIGS. 3 to 8 show representations of screen displays, for example screen displays of a computer processing system implementing a client system 102 of FIG. 1 or FIG. 2, or of another computer processing system. In each case the screen display 300 may form all or a portion of a physical display screen of the client system 102. FIGS. 3 to 8 are shown in schematic form, to illustrate user interface functionality. The layout and presentation of the screen displays may vary widely between implementations.

Referring to FIG. 3A, an idea issue screen display 300 is shown. The idea issue screen display 300 displays indicia relating to an idea issue, for example an idea issue as described with reference to FIG. 2. The screen display 300 includes an idea identifier 301. The displayed idea identifier 301 corresponds to or is related to an identifier for the idea issue within the project management system, which may be a globally unique identifier (GUID).

A title 302 and idea description 303 for the idea issue may also be displayed. The title may be entered by a user of a client system 102 when creating the idea issue in the project management system 104, thereby allowing for example a text title identifying the subject matter of the idea for the idea issue. Similarly, the idea description 303 may also be entered by a user, to allow more detail to be entered in relation to the idea issue. The idea issue may also include a checklist 304. The checklist 304 may include tasks associated with the idea issue, which tasks may be predetermined for idea issue types within the project management system 104 and/or may be user entered. The idea issue may also include a set of idea links 305. These may be used, for example, to link to materials inside and/or outside of the project management system 104 that contain more information on the idea issue.

The idea issue screen further includes idea activity 306. Idea activity 306 has a function of displaying activity relating to the idea that is the subject of the idea issue. An example of activity is a user operating a client system 102 to enter a comment in relation to the idea. One mechanism for the use to enter a comment is to select the selectable “Add comment” indicia 307. In response the screen display 300 may transition to another display screen for entering the comment and saving it to the issue. The comment is then displayed within idea activity 306. For example, “Activity A” 308 may be a comment. Another example of activity is a user operating a client system 102 to enter evidence in relation to the idea. One mechanism for the use to enter a comment is to select the selectable “Add evidence” indicia 309. In response the display screen 300 may transition to another display screen for entering the comment and saving it to the issue, for example the display screen 400 of FIG. 4A. Selectable indicia show all activity 310, evidence only 311 and comments only 312 are provided in the screen display 300. These operate to controllably display both comments and evidence, only evidence or only comments within the idea activity 306, transitioning between these display modes responsive to user selection of the respective selectable indicia. Selectable indicia select sources 313 provides a function to limit the comments and/or evidence within idea activity 305 by the source of the comment or evidence. The source in some embodiments is selected by a drop-down menu, indicated by the “V” within the selectable indicia select sources 313. A scroll bar 314 or similar operates to indicate a scrolling position and/or allow scrolling through the issue idea, for example to view information within idea activity 306 that is not currently displayed.

The screen display 300 also includes a region for displaying a metric 315, generically shown as “Metric A” in FIG. 3A. Metric A may relate to Activity A. The operation of the metric 315 is explained in more detail with reference to FIGS. 4 to 8.

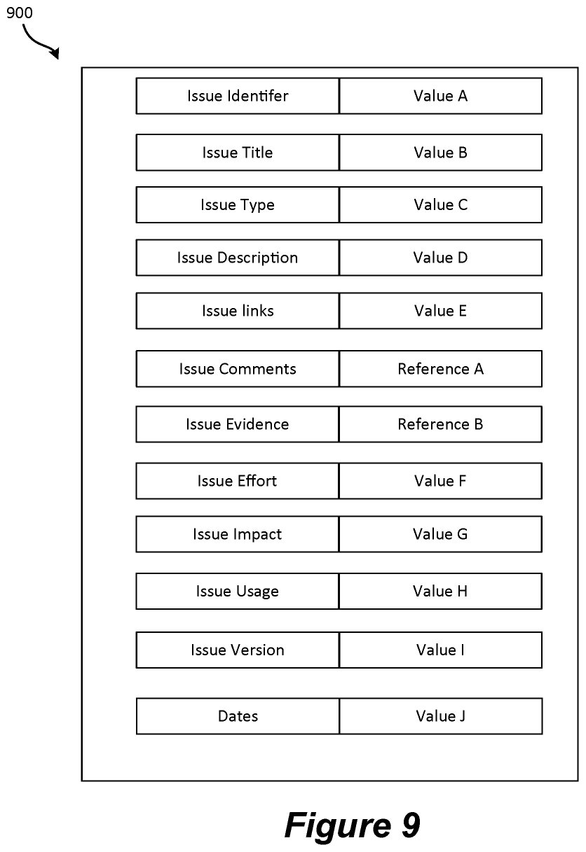

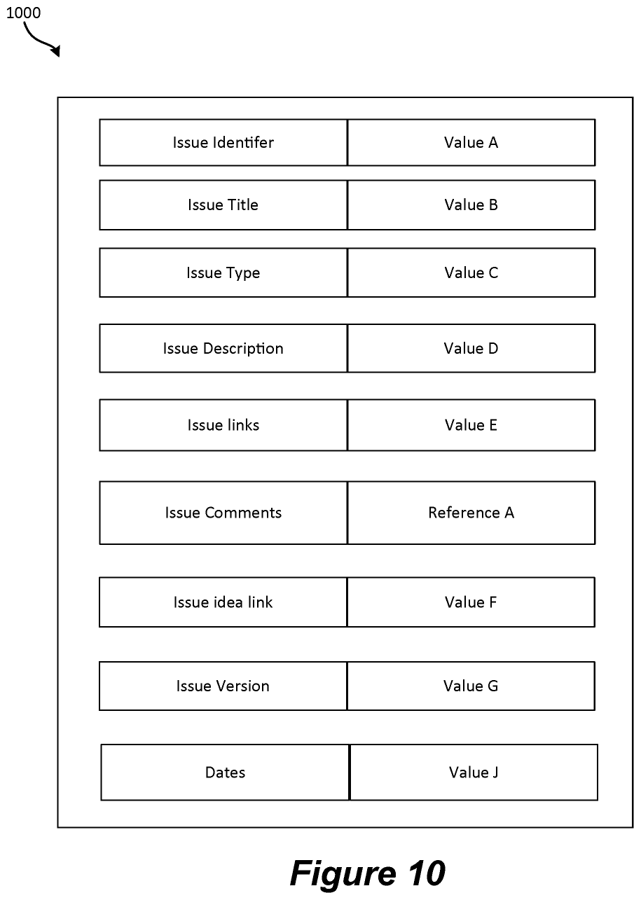

The screen display 300 also includes selectable indicia 316, in this example a button “Send to project queue”. Selection of indicia 316 causes the issue tracking system to transfer or link the idea issue type to a feature issue type, as described herein above. The transfer may involve creating one or more data entities defining the feature issue type, based on one or more data entities defining the idea issue type. An example is described with reference to FIGS. 9 and 10.

FIG. 3B shows idea activity 306, updated to include a progress indicator 314. The update to show the progress indicator may be displayed as part of idea activity 306 following utilisation of the button “Send to project queue” to transfer or link to an idea issue type to a feature issue type. In some embodiments the progress indicator 314 is a graphical indicator, for example a progress bar that fills in as stages of a project associated with the feature issue are completed. In some embodiments the progress indicated by the progress indicator 314 is a calculated value, calculated from a mathematical combination of a plurality of variables associated with the feature issue and which relate to the progress of the project associated with the feature issue.

Other information or variables that may be displayed as part of the screen display 300 (but not shown in FIG. 3A or 3B) is an indicator of a number of votes for an idea. The system may include a user interface that enables various users to enter a vote in favour of the idea, count the number of votes and present indicia representing or otherwise based on the count. An indicator of an effort may be displayed, for example an indicator of 1 to 5, where 1 is the lowest effort and 5 is the highest effort.

FIG. 4A shows an example screen display 400 for a user to enter evidence or other material for an idea issue. As described above, screen display 400 may be displayed responsive to user selection of add evidence indicia 308. The screen display 400 includes the idea identifier 301 and title 302 of the idea issue. A link box 401 is displayed, which the user may select and enter (e.g., by typing on a keyboard or pasting a link previously copied from a clipboard etc.) a link to a source of evidence or other material. The link may be, for example, a web address. The source of the material at the linked site may be, for example, an analytics engine, a survey application, or a feedback application, with the link pointing to a site with data published by the analytics engine, a survey application, or a feedback application. The link may be as described with reference to FIG. 2 and the link request is communicated from the client system 102 to the project management system 104 responsive to selection of save 402. More than one link may be added, to add further material, for example by entering a link, selecting save 402 and repeating the save process. Selecting close 403 may cause a return to the screen display 300. For example, “Activity A” of FIG. 3 may be material sourced from a link previously entered using screen display 400. In some embodiments a first address is entered in the link box 401 and responsive to entry of the first address a request is made, according to an application programming interface (API), to the address identified by the first address. The system then receives from the second computer system a list of available material, each associated with a link, and the user can select an item from list for use as the evidence or other material.

FIG. 4B shows another example screen display 450 for a user to enter evidence or other material for an idea or issue. The screen display 450 is a screen of an application for navigating documents, websites, or other information, for example a web browser with an installed extension to provide the functionality described below. The web browser displays an internet address for the information displayed by the browser, which in this example includes a body of text 452, indicated by three boxes in FIG. 4B to represent three parts of the text. The three parts are, in the middle box, text that has been selected by a user of the application (e.g., the user of the web browser), and in the upper and lower boxes text that has not been selected by the user.

The screen display 450 includes a selectable button, an Idea button 453. In response to receiving selection of the Idea button 453, a menu 464 is displayed. The menu 464 includes an item for selecting a project, a select project button 454. In the embodiment shown, in response to selecting the select project button 454, a list of projects is displayed, the list of projects corresponding to projects maintained by the project management system 104. The list of projects may be limited to the projects associated with the current user, which may have previously provided credentials to establish their identity. The menu 464 also includes an item for selecting an idea, a select idea button 455. In the embodiment shown, in response to selecting the select idea button 455, a list of ideas is displayed, the list of ideas corresponding to ideas maintained by the project management system 104 that are ideas of the project identified using the select project button 454. By way of example, both the select project button 454 and select idea button 455 may be in the form of a drop-down menu and/or a search interface allowing searching of idea titles, identifiers, or other information for the idea. The drop-down menu or other interface may include an option to create a new project or a new idea, selection of which causes a screen display to be displayed for creating a new project or idea respectively in the project management system 104. In some embodiments the select project button 454 and the select idea button 455 is automatically populated by the system. For example, if the user has the project management system open on their computer and is in a project and displaying an idea, then that project and that idea may be pre-populated. If required, the user may change the idea within the prepopulated project by selecting the select idea button 455 and similarly may change to another project using the select project button 454.

An idea link field 456 includes a link to the network address that the browser is displaying. This information may be automatically populated. Similarly, the text that was selected by the user is automatically populated into text field 457. A button 458, when selected, returns to the display of the body of text 452, to enable another portion of the text to be selected and automatically populated into the text field 457 in addition to the earlier selected text. A free text field 459 allows the user to enter their own text, for example a note as to why they have included a link to this side and included this text for the idea. An add labels 460 button allows the user to select a label to associate with the insight. The labels may be used for filtering or sorting insights associated with an idea. An add button 461 causes the insight to be added to the idea, a cancel button 462 causes the menu 464 to close without adding the insight to the idea. A photo button 463 enables a user to enter a screen shot of the screen display of the browser (not including the menu 464), instead of or in addition to selected text.

An extension or added functionality, similar to the browser extension described above, may be added to other applications. Where the applications themselves provide the relevant material, the link will provide an identification of the computer system on which the application is running, as well as an identification of the material to be provided.

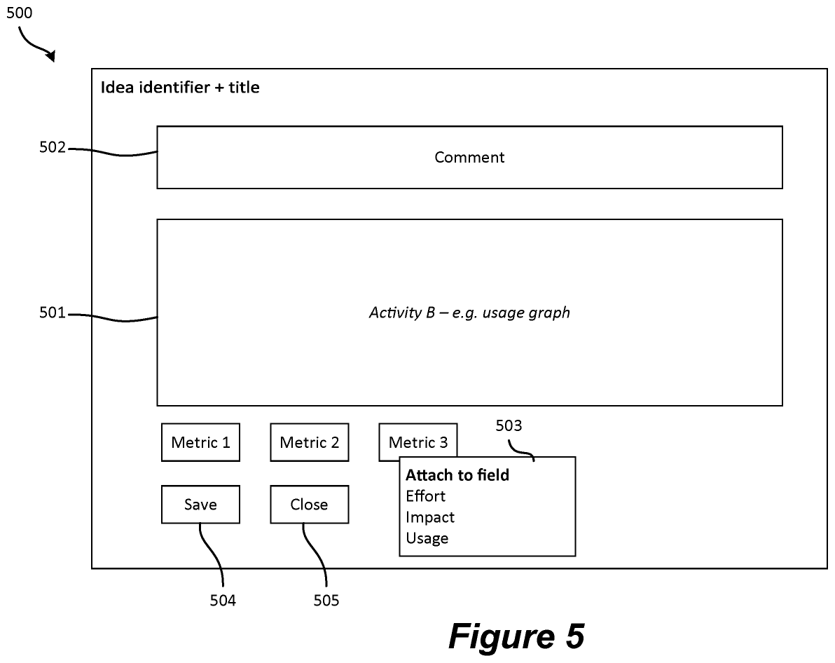

FIG. 5 shows an example screen display 500 for a user to configure linked material, for example material identified by a link received via screen display 400. Screen display 500 may be displayed responsive to a link being entered. For example, a user may have selected save 402 in screen display 400 and responsive to that the project management system may cause the display of screen display 500. Material region 501 contains the evidence or other material referred to by the link, in this example indicated by “Activity B—e.g., usage graph”. The usage graph may be generated by an analytics system and sent to the project management system responsive to a request from the project management system, the particular usage graph requested being indicated by the link. In some embodiments, the project management system provides a function for a user to enter a comment on the material. For example, a comment region 502 may be provided to receive a user entry of text or other input. A user may therefore provide explanatory material in relation to the linked material indicating for example why the material was considered relevant or providing context or background to the material.

The linked material may include one or more metrics. The project management system may then display a metric in a selectable region of the screen display 500. FIG. 5 shows an example of three metrics: Metric 1, Metric 2, and Metric 3. The displayed metrics may include an indicator of what the metric is and a value of the metric. For example, Metric 3 may be MAU:1000, indicating that the Monthly Average Usage (MAU) within the linked material has a value of 1000. Responsive to a selection action in respect of one a metric, one or more selectable options 503 for associating the metric with a field of an issue are displayed. The example of FIG. 5 shows three fields of an issue that may be linked with a metric from linked material, namely Effort, Impact and Usage. The linked fields may be defined for the idea issue type. The displayed fields may have corresponding fields in the data structure forming the idea issue type or corresponding fields in another data entity referenced by the data structure forming the idea issue type.

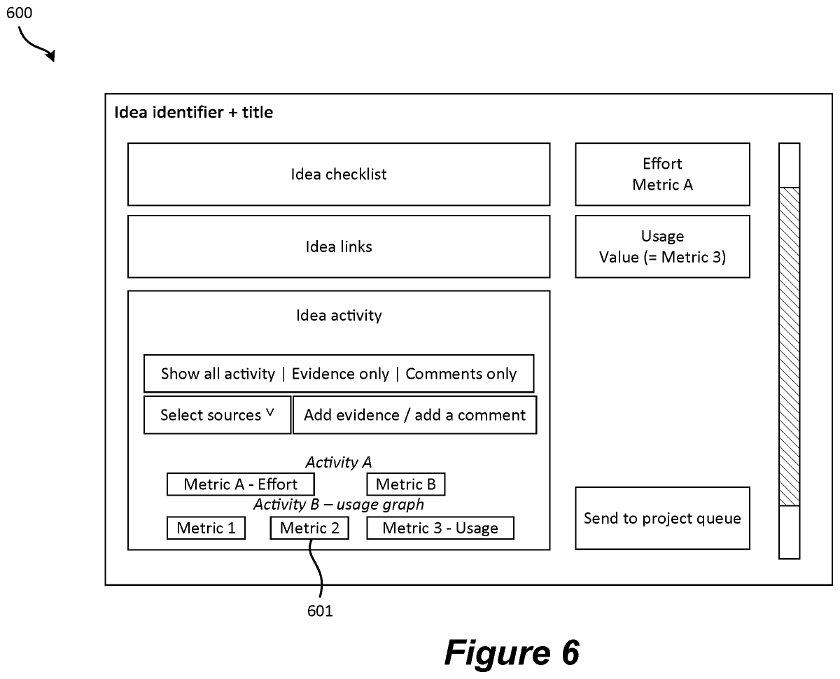

Responsive to user action, the project management system associates the selected metric with the selected issue field. Referring to FIG. 5, an association may be made if a user selects Usage in the selectable options 503. In some embodiments the display of Metric 3 may be updated to reflect the selected association, for example by adding an indicator of the selected field (e.g., see FIG. 6 “Metric 3—Usage”). A user may then select Save 504 to confirm the association, although in some embodiments this may not be required or provided as an option separate to the selection from the selectable options 503. Once a user has completed making the associations of one or more metrics, each with one or more issue fields, the user may select Close 505, to complete the save process.

FIG. 6 shows a screen display 600, including an idea issue with linked materials. The screen display 600 may be an updated version of the idea issue screen display 300, following the linking of Activity B to the issue (e.g., as described with reference to FIGS. 3 and 4) and following the association of Metric 3 to the Usage field of the issue (e.g., as described with reference to FIG. 5). Only the new features of screen display 600 over those of screen display 300 are described. Other features remain as described with reference to FIG. 3. The “idea description” region of FIG. 3 is not shown in FIG. 6, representing that the display has been scrolled downwards, for example to reveal Activity B.

The displayed issue includes as activity the associated Activity B, for example a usage graph (represented by a text label only in FIG. 6). The metric(s), in this example three metrics of the linked Activity B are also displayed, for example below the usage graph. The idea displays the metric associated with usage in metric region, namely Metric 3, with indicia showing that it is associated within the idea activity region of the display. In some embodiments the metric is also displayed in a second metric region 601. In the example the second metric region 601 includes indicia of the associated field (“Usage” in the example) and indicia of the value of the metric.

FIG. 6 also includes two displayed metrics for Activity A, which were not shown in the example of FIG. 3, Metric A and Metric B. Metric A has been linked to the Effort field of the issue and FIG. 6 therefore depicts this information on metric 315 transferred across from FIG. 3. In some embodiments the metrics displayed as part of the idea activity are selectable for association with an issue field in a similar manner as described with reference to FIG. 5. For example, a user may select Metric B and in response to receiving the selection the project management system may display options of fields to which the metric may be linked. If the user selected Usage, the project management system determines that usage already has an associated value, and an action is taken in response to the determination. In some embodiments, the action may include any one or more of: generating a message that the field has already been associated; generating a message requesting user selection of only one of the metrics indicated (e.g., the previously associated metric or the currently associated metric); and generating a message requesting user input determining a weighting between the two (or more) metrics associated with the same field.

Whilst FIG. 6 shows a screen display for a single issue, the project management system may be configured to provide screen displays of a plurality of issues. The association of material from activity in relation to an issue (e.g., the metrics described herein) to a field of the issue provides a mechanism to display the material across different types of screen display.

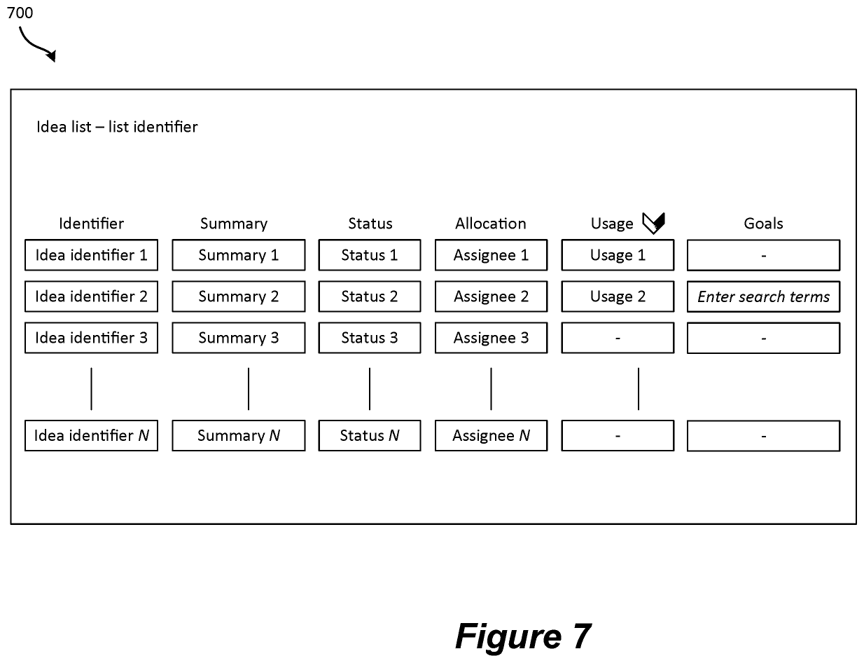

FIG. 7 shows screen display 700 including a list view of a plurality (1 to N) of issues for ideas. It includes a plurality of columns including a column for the identifiers of the issues, which may correspond to the “idea identifier” in FIGS. 3 to 6 and a summary column, which may correspond to the “idea description” in FIG. 3. FIG. 7 also shows a status column, which may reflect a status predetermined for the stage of a workflow for the idea issue type and an allocation column, which refers to a resource (e.g., a person or a team) allocated to the idea, for example an allocation at a current point within a workflow. Although not previously shown, the status and/or allocation may form part of the displayed issue (e.g., in FIG. 3 or FIG. 6). FIG. 7 also includes a column Usage, for the usage field associable with one or more metrics drawn from activity of an idea, as described herein. Column Usage may be sortable, for example by magnitude of the value of the associated metric, allowing for example ideas with the highest usage to be displayed at the top of the list. When more than one field of the idea has been linked, then the columns may reflect this. For example, another screen display similar to FIG. 7 may include columns for Effort and Impact (see FIG. 5) and may be sortable by those.

In some embodiments a field for an issue, displayable in the view of FIG. 7 and displayable in other views, is a field from another system. As described herein above, the API with the other system may be configured to that the other system provides a list of available material that the user can select from. The API between the project management system and the other system may provide for a search interface to be provided by the project management system. This may be useful, for example, where there is a large number of possibilities. FIG. 7 illustrates an example in which a user has selected to add a field of ‘Goals’ for one or more ideas. The project management system is configured to communicate with another system to receive the goals. A user can select the Goal field for an idea, which initiates a search user interface. In FIG. 7 this places a prompt on the screen display “Enter search terms”. The user may then enter a search term, which is communicated to the other system and the results are displayed, for example in a list extending down from the selected Goal field. The user then selects the desired search result, following which the selected Goal is displayed as the Goal field for the idea, which in this case is the idea with the identifier “Idea identifier 2”.

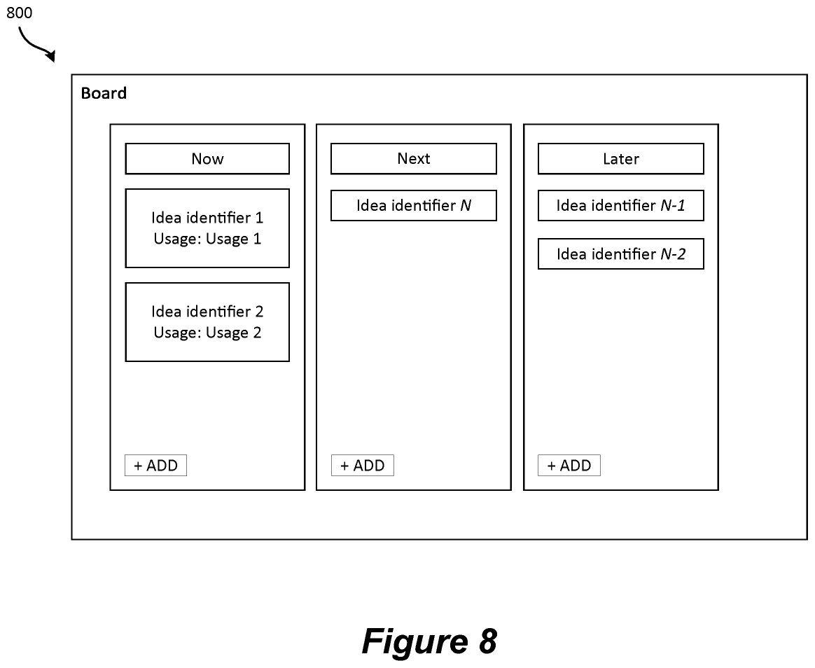

FIG. 8 shows a screen display 800 including a board view of a plurality (1 to N) of issues for ideas. The board view includes a tile for each idea issue and the tile includes indicia of the metric associated to a field of an issue field. Two tiles are shown in FIG. 8 displaying metrics for usage. Other tiles may display other metrics and one or more tiles may display more than one metric. The example board view includes columns for Now, Next, and Later, indicating for example what ideas should be considered at present or in the near future, what ideas should be considered after that and what ideas have been deferred for later consideration.

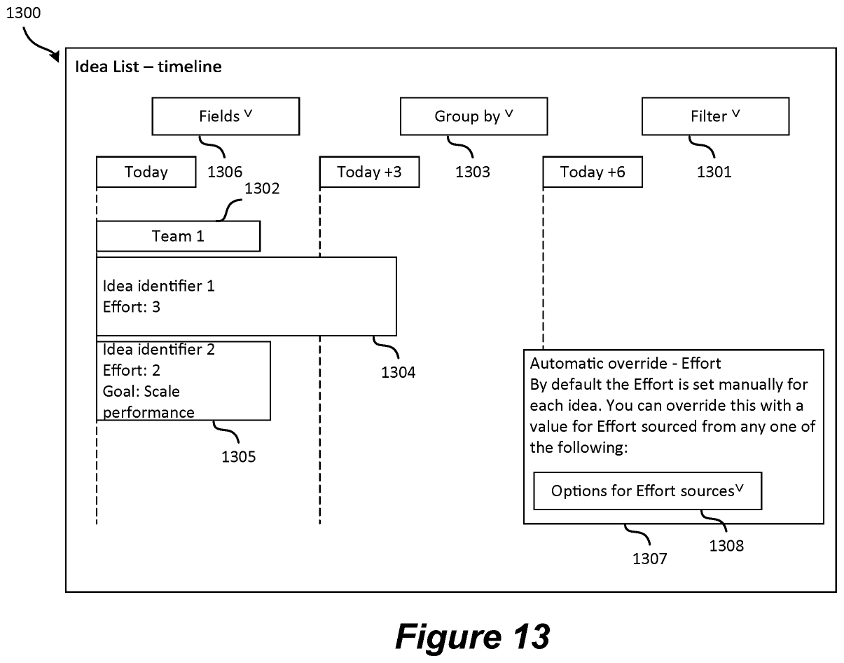

FIG. 13 shows a screen display 1300 including a timeline view of a plurality of issues. The issues may be idea issue types, feature issue types or a combination of idea and feature issue types. A feature issue type displayed in the timeline may include one that is linked to an idea issue type, for example due to being created based on an idea issue type as described herein. In some embodiments the timeline displays only idea issue types or only feature issue types.

In other embodiments both types are displayable, with the two types of issues being displayed differently or the display otherwise including indicia enabling a user to distinguish the types of issues. In some embodiments of displaying both types of issues, the user may operate one or more filter user interface elements to cause the display of both types of issues, or one or the other of the issues. An example filter user interface element 1301 in the form of a drop-down menu is shown in FIG. 13. The filter user interface element 1301 may allow filtering by other criteria, such as by team indicator or by the value of the Effort field (see below). For brevity of explanation, in the following description of FIG. 13 reference is made to only idea issue types, but the same functionality may be present for feature issue types.

The timeline includes, in the embodiment shown, time extending along a horizontal axis, with demarcations every 3 months. The presentation of a timeline may vary in other embodiments.

A team indicator 1302, which in the example shown displays a team name of “Team 1” indicates an allocation to that team of issues. Team 1 may, for example be “Assignee 1” shown in FIG. 7. In the example shown both ideas displayed in the timeline and indicated by “Idea identifier 1” and “Idea identifier 2” have been allocated to Team 1. Another team indicator (not shown) may be displayed on the timeline, above a group of ideas allocated to that team. The arrangement of the display of ideas by their allocated team may be selected by the user operating one or more group user interface elements. An example group user interface element 1303 is shown in FIG. 13, in the form of a drop-down menu. The group user interface element 1303 may allow grouping by other criteria, such as by the value of the Effort field (see below).

In the illustrative example of FIG. 13, two ideas 1304 and 1305 are displayed in the timeline. The idea 1304 has an end date about 4 months from the current date (“Today”) and the idea 1305 has an end date about 2 months from the current date. The end dates are indicated by the right end termination of the displayed bar representing the idea. Each idea may have a start date of the current date, or a start date in the past. In some embodiments a user can scroll the timeline, including scrolling to see time periods before the current date.

One or more fields relating to an idea are displayed in the timeline view. In the example of FIG. 13 a single field of Effort is displayed for the idea 1304. The Effort field was described previously herein, and the timeline view shows the value of the Effort field, together with indicia to identify that the displayed value is the Effort field. For the idea 1305 both an Effort field and a goal field is displayed. An example of a goal field was described with reference to FIG. 7.

Which fields are displayed may be configurable by a user. An example field selector interface element 1306 is shown in FIG. 13, in the form of a drop-down menu. The field selector user interface element 1306 may allow selection of one field or more than one field to display together with the representation of an idea in the timeline.

In some embodiments the timeline view of the screen display 1300 provides a user interface allowing a user to adjust one or more variables displayed in the timeline view. An example of a variable is the end date for an idea. A user may operate a user input device, for example a click and point device, to drag the end of a bar representing an idea to a different location in the timeline. In doing so, the end date for the idea is updated in the data records and the new end date is displayed in both the timeline view and in one or more other user interfaces for the idea. Another example of a variable is the value of the Effort field. A user may operate a user input device, for example a keyboard, to enter a new value for the Effort field associated with an idea. In doing so, the value of the Effort field is updated in the data records and displayed in both the timeline view and in one or more other user interfaces for the idea.

The project management system may implement other boards. The project management system may also implement other list views to that of FIG. 7 and other types of user interface that identify and display a plurality of issues. The project management system may also implement other timeline views to that of FIG. 13.

Any of the information from one view may be displayed in another view. For example, the status information from FIG. 7 may be displayed in screen display 600 (despite not being shown in FIG. 6). Similarly, any of the information in any of the views may be associated with a field, which field may in turn be associated with external information or another field, for example by being listed as one of the selectable options 503 (see FIG. 5). Using again the example of status information, this may be sourced from another system or sourced from a status associated with a linked feature issue type. The project management system may be configured to replace any value it has in its field for status (or other field) with the value form the other system or value associated with the linked feature issue type.

As described herein, the values of some fields may be linked to other data. For example, as described with reference to FIG. 5, a metric may be linked to the Effort field. In another example, the value of a field may be sourced from or based on data retrieved from another system. For example, a separate system may identify a date for an issue, such as an idea issue type or a feature issue type. If a user seeks to vary the value of the field, then this may create a conflict between the data. For example, referring to the timeline view of FIG. 13, if a user seeks to vary the end date or value of the Effort field and these have been determined based on other data, then there is an inconsistency between that other data and the date or value as varied by the user.

In some embodiments the project management system is configured to provide an option to override data. In some embodiments the project management system by default uses any values that are manually entered. If the field being manually changed is associated with other data, then a warning may be displayed before making the change, for example a pop-up message indicating that the field is linked with other data. The pop-up message may identify the other data. In other embodiments the project management system by default prevents manual change of any linked fields. In some embodiments the project management system includes a user interface allowing a user to select whether any manually entered data for a field is automatically overridden by the linked data. For example, if a user had first entered a value of the Effort field using the timeline view of FIG. 13, and only subsequently created a link to Metric A as described with reference to FIG. 5, then the project management system may automatically override the value of the Effort field in the timeline view with the value associated with Metric A.

The user interface allowing a user to select whether any manually entered data for a field is automatically overridden may be displayed in response to a field being added to a view. For example, if a user selected the Effort field using the field selector interface element 1306 of FIG. 13, an option box 1307 (see FIG. 13) may be displayed. The option box 1307 identifies the field that it relates to, in this case Effort, and includes a selectable element 1308 enabling the selection of another data source to be the default data source. The other data source may be an internal source in the project management system or an external linked data source. As indicated by the drop-down box representation, there may be a plurality of options for the other data source, but there could also be only one for one of more of the fields. Once an option to implement automatic override has been selected, the project management system may prevent manual override of the value of the affected field or fields. If a user attempts to change the value, an error message may be displayed, optionally indicating that the value is linked to other data and identifying that other data.

FIG. 9 shows a diagrammatic representation of information in a data entity defining an issue. Several fields are shown, which may be included in document database, relational database, or other type of computer storage, for example a database 114 (see FIG. 1). In some embodiments the information is retained across a plurality of data entities, which are all associated with the issue. The following description of embodiments in relation to FIG. 9 assumes a single data entity 900. In various embodiments the data entity or entities defining an issue may include other fields and some of the fields shown may be omitted or replaced by fields have an equivalent function.

The data entity 900 includes an Issue Identifier and associated value (Value A). The Value A identifies to the issue tracking system the issue and distinguishes from other issues. The Value A may be or may be related to the displayed idea identifier 301 described herein and may be a globally unique identifier (GUID). The data entity 900 includes an Issue title and associated value (Value B). The title may be or may be related to the displayed title 302 described herein. The data entity 900 includes an Issue Type and an associated value (Value C). The Issue Type may determine what fields are included in the data entity 900. The example data entity 900 of FIG. 9 is for an idea issue type described herein and Value C is therefore a value indicating the idea issue type (see FIG. 10 for an example of another issue type). The data entity 900 includes an Issue Description and an associated value (Value D). The Value D may be or may be related to the displayed idea description 303 described herein. The data entity 900 includes an Issue Links field and an associated value (Value E), which may correspond to the links displayed as idea links 305 described herein. The data entity 900 includes a Comments field and an associated value (Reference A). The value Reference A may point to another data entity containing the comments or containing references to comments. Alternatively, the comments may be within the data entity 900 as values of the data entity. Similarly, an Issue Evidence field has an associated value (Reference B), with reference B containing links or information received by the issue tracking system, for example as described herein with reference to FIG. 4A or FIG. 4B. The data entity 900 includes in this example three displayable fields that can be linked to material received by the issue tracking system. The example embodiment of FIG. 9 corresponds to the example embodiments described with reference to FIG. 5 of including displayable fields for Effort, Impact and Usage. The values of these fields (Values F-H respectively) include the references to the material and include any processing required in relation to the material, for example to accommodate a metric that is a combination of variables from the material. The data entity 900 also includes an Issue Version and an associated value (Value I). By way of example, the Value I may be a numerical value that is incremented with each change to the data entity 900, including the addition or change of any of the values of the data entity 900. The data entity 900 may further include a Dates field and associated values (Value J). The dates may include a date of creation of the idea, a date of edit of the idea, a start date for the idea and/or an end date for the idea. The start and end dates may be used for a timeline view of the idea. It will be appreciated that the dates need not appear in the same field and could be split into separate fields. Alternatively, the dates may be a separate data entity to the data entity 900, but associated with the data entity 900, for example by a value of Value E for the Issue links field.

FIG. 10 shows a diagrammatic representation of information in a data entity defining an issue. Several fields are shown, which may be included in document database, relational database, or other type of computer storage, for example a database 114 (see FIG. 1). In some embodiments the information is retained across a plurality of data entities, which are all associated with the issue. The following description of embodiments in relation to FIG. 10 assumes a single data entity 1000. In various embodiments the data entity or entities defining an issue may include other fields and some of the fields shown may be omitted or replaced by fields have an equivalent function.

The data entity 1000 may be a feature issue type, as indicated by the Value C of the Issue Type field. The data entity 1000 may have been created, for example, responsive to selection of selectable indicia 316 “Send to project queue”, described with reference to FIG. 3 (see also FIG. 6).

The data entity 1000 includes an Issue Identifier and an associated value (Value A). Value for the data entity 1000 may be different to the issue identifier value of the data entity 900. A linkage to data entity 900 (e.g., to the idea issue type that was the source of the feature issue type) is indicated by an Issue idea link field and its associated value (Value F). For example, Value F may be the issue identifier value of the data entity 900. Accordingly, the issue tracking system can retrieve any information within or associated with the data entity 900, for display in association with the feature issue type defined by data entity 1000. The data entity 1000 also includes Issue Title, Issue Description, and Issue links fields with associated values (Values B, D and E respectively). In some embodiments the values are copied from the related field values of the data entity 900, whereas in other embodiments new values are received and stored in a like manner as described herein for the idea issue type. The data entity 1000 also includes an Issue Version filed and associated value (Value G). This may operate in the same way as the version field for data entity 900, for example incrementing with each change to the data entity 1000. The data entity 1000 also includes a Dates field, which like the corresponding field of the data entity 900 may hold one or more dates, such as a date of creation of the idea, a date of edit of the idea, a start date for the idea and/or an end date for the idea. The start and end dates may be used for a timeline view. Alternatively, the dates could be in another data entity, for example a data entity identified by a value in the Issue links field.

Various embodiments and features of the present disclosure are implemented using one or more computer processing systems. For example, a project management system 104 implementing processing according to the sequence diagram of FIG. 2 in combination with providing a user interface including screen displays of FIGS. 3 to 8 may be implemented by a computer processing system. The client system 102, server system 116 and product system 120 may similarly be implemented by computer processing systems, adapted to their tasks.

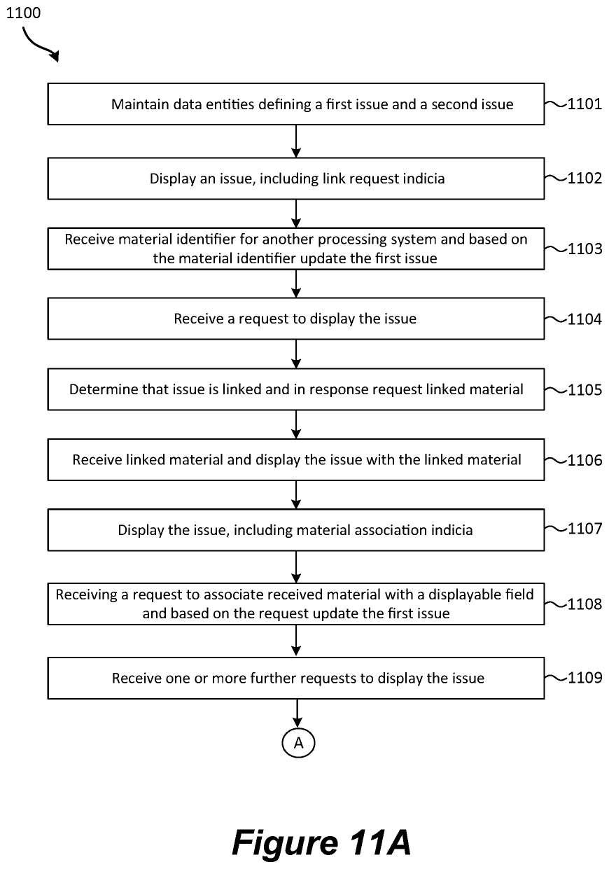

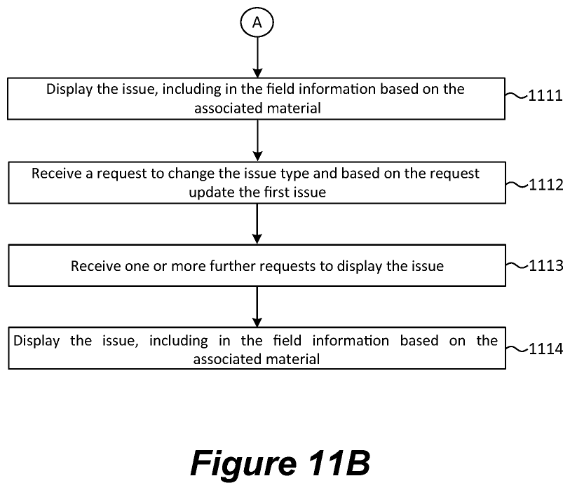

FIGS. 11A, 11B show an example process performed at an issue tracking system, for example an embodiment of issue tracking system described with reference to FIG. 1 and/or FIG. 2. The issue tracking system may include a user interface described with reference to FIGS. 3 to 8 and/or may maintain data entities described with reference to FIGS. 9 and/or 10.

The method 1100 performed at an issue tracking system, includes process 1101 of maintaining data entities defining issues. Process 1101 may include maintaining, in data storage readable by a first computer processing system, data entities defining a plurality of issues for an issue tracking system, including at least one first data entity defining information for a first issue and at least one second data entity defining information for a second issue, different to the first issue.

Process 1102 includes displaying an issue, including link request indicia. Process 1102 may include receiving, at the first computer processing system, a first request for the first issue and in response to the first request causing display by the issue tracking system of a first user interface for the first issue, including display of at least one display screen comprising first information defined by the at least one first data entity for the first issue and at least one selectable link request indicia. Responsive to selection of a said link request indicia, one or more user interface elements for receiving link request information may be displayed, for example a text receiving field for a machine-readable address.

Process 1103 includes receiving a material identifier for another processing system and based on that updating the first issue. Process 1103 may include receiving at the first computer processing system link request information for material accessible by a second computer processing system, different to the first computer processing system, the link request information comprising at least one identifier of the second computer processing system and the material and updating, by the first computer processing system, the at least one first data entity with the at least one identifier.

Process 1104 includes receiving a request to display the first issue. Process 110 may include receiving, at the first computer processing system after the updating of process 1103, a second request for the first issue.

Process 1105 includes determining that the first issue is linked to the material (as a result of process 1103) and in response to the determination, the issue tracking system requests the linked material. Process 1005 may include, responsive to the second request for the first issue generating, based on the identifier, a request to the second computer processing system for the material.

Process 1106 includes receiving the linked material and displaying the received linked material with the first issue. Process 1106 may include receiving the material from the second computer processing system, and causing display by the issue tracking system of a second user interface for the first issue, the second user interface including at least one display screen comprising the first information defined by the at least one first data entity for the first issue and second information comprising at least a first part of the received material and a second part of the received material, different to the first part. The second user interface may also include at least one selectable material association indicia.

Process 1107 includes receiving a request to associate received material with a displayable field and based on the request update the first issue. Process 1107 may include responsive to selection of one of the material association indicia, displaying one or more user interface elements for associating at least the first part of the material with at least one displayable field of the issue and receiving at the first computer processing system material association information requesting association of the first part of the material with a said displayable field and in response updating content of the at least one first data entity with the association.

Process 1108 includes receiving at least one further request to display the issue and process 1109 includes displaying the issue based on the association of process 1107. Process 1108 may include receiving, at the first computer processing system after the updating of the at least one first data entity with the association, a third request for the first issue and responsive to the third request: based on the content of the at least one first data entity with the association, causing display by the issue tracking system of a third user interface for the first issue. The third user interface may include at least one display screen including information from the first data entity for the first issue and information based on the first part of the material, displayed to represent an association of the first part of the material to the first issue. The third user interface may also include information from the second data entity for the second issue, displayed to represent an absence of association of the first part of the material to the second issue.

Process 1110 includes changing the issue type based on a received request. For example, the first issue may have a first issue type within the issue tracking system, associated with a first workflow. Process 1110 may then include receiving at the first computer processing system a request to change the first issue to a second type associated with a second workflow, different to the first workflow, and in response updating the first data entity from indicating the first issue type to the second issue type and maintaining the update of the first data entity with the at least one identifier. Process 1110 may include maintaining the update of the first data entity with the association of the first part of the material to the first issue.

Process 1111 includes receiving at least one further request to display the issue, which now has the changed (second) issue type based on process 1110. Process 1112 includes displaying the issue, including display of material based on the at least one identifier (e.g., material sourced from the second processing system) and display of information based on the first part of the material (e.g., a metric as described herein).

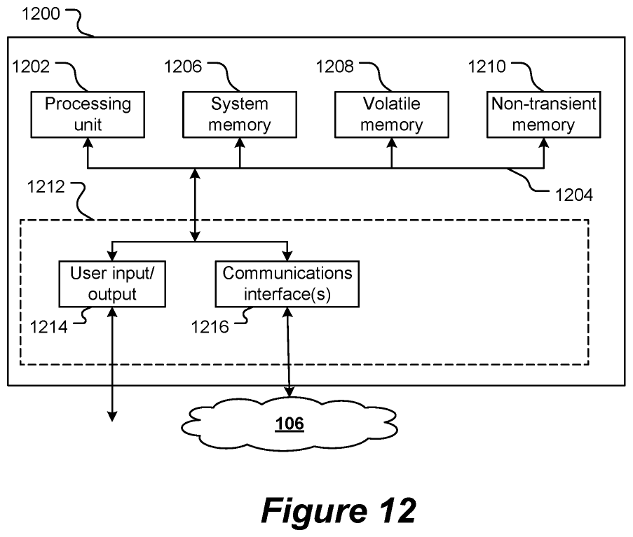

FIG. 12 provides a block diagram of a computer processing system 1200 configurable to implement embodiments and/or features described herein. System 1200 is a general-purpose computer processing system. The general structure of computer system depicted in FIG. 12 may be suited for providing aspects of the client system 102, product system 120, aggregator system 116 and project management system 104. It will be appreciated that FIG. 12 does not illustrate all functional or physical components of a computer processing system. For example, no power supply or power supply interface has been depicted, however system 1200 will either carry a power supply or be configured for connection to a power supply (or both). It will also be appreciated that the particular type of computer processing system will determine the appropriate hardware and architecture. For example, the processing and storage capability of the product system 120, aggregator system 116 and project management system 104 will typically be greater than the client system 104. Alternative computer processing systems suitable for implementing features of the present disclosure may have additional, alternative, or fewer components than those depicted.

Computer processing system 1200 includes at least one processing unit 1202—for example, a general or central processing unit, a graphics processing unit, or an alternative computational device). Computer processing system 1200 may include a plurality of computer processing units. In some instances, where a computer processing system 1200 is described as performing an operation or function all processing required to perform that operation or function will be performed by processing unit 1202. In other instances, processing required to perform that operation or function may also be performed by remote processing devices accessible to and useable by (either in a shared or dedicated manner) system 1200.

Through a communications bus 1204, processing unit(s) 1202 and one or more computer readable storage devices are in data communication. The storage devices store instructions and/or data for controlling operation of the processing system 1200. In this example system 1200 includes a system memory 1206 (e.g., a BIOS), volatile memory 1208 (e.g., random access memory such as one or more DRAM modules), and non-volatile (or non-transitory) memory 1210 (e.g., one or more hard disk or solid-state drives). Such memory devices may also be referred to as computer readable storage media or data storage.

System 1200 also includes one or more interfaces, indicated generally by 1212, via which system 1200 interfaces with various devices and/or networks. Generally speaking, other devices may be integral with system 1200, or may be separate. Where a device is separate from system 1200, connection between the device and system 1200 may be via wired or wireless hardware and communication protocols and may be a direct or an indirect (e.g., networked) connection.

Wired connection with other devices/networks may be by any appropriate standard or proprietary hardware and connectivity protocols, for example Universal Serial Bus (USB), eSATA, Thunderbolt, Ethernet, HDMI, and/or any other wired connection hardware/connectivity protocol.

Wireless connection with other devices/networks may similarly be by any appropriate standard or proprietary hardware and communications protocols, for example infrared, Bluetooth, Wi-Fi; near field communications (NFC); Global System for Mobile Communications (GSM), Enhanced Data GSM Environment (EDGE), long term evolution (LTE), code division multiple access (CDMA—and/or variants thereof), and/or any other wireless hardware/connectivity protocol.

Generally speaking, and depending on the particular system in question, devices to which system 1200 connects—whether by wired or wireless means—include one or more input/output devices (indicated generally by input/output device interface 214). Input devices are used to input data into system 1200 for processing by the processing unit 1202. Output devices allow data to be output by system 1200. Example input/output devices are described below; however, it will be appreciated that not all computer processing systems will include all mentioned devices, and that additional and alternative devices to those mentioned may well be used.

For example, system 1200 may include or connect to one or more input devices by which information/data is input into (received by) system 1200. Such input devices may include keyboards, mice, trackpads (and/or other touch/contact sensing devices, including touch screen displays), microphones, accelerometers, proximity sensors, GPS devices, touch sensors, and/or other input devices. System 1200 may also include or connect to one or more output devices controlled by system 1200 to output information. Such output devices may include devices such as displays (e.g., cathode ray tube displays, liquid crystal displays, light emitting diode displays, plasma displays, touch screen displays), speakers, vibration modules, light emitting diodes/other lights, and other output devices. System 1200 may also include or connect to devices which may act as both input and output devices, for example memory devices/computer readable media (e.g., hard drives, solid state drives, disk drives, compact flash cards, SD cards, and other memory/computer readable media devices) which system 1200 can read data from and/or write data to, and touch screen displays which can both display (output) data and receive touch signals (input).

System 1200 also includes one or more communications interfaces 1216 for communication with a network, such as network 106 of environment 100. Via a communications interface 216 system 200 can communicate data to and receive data from networked devices, which may themselves be other computer processing systems.

System 1200 stores or has access to computer applications (also referred to as software or programs)—e.g., computer readable instructions and data which, when executed by the processing unit 1202, configure system 1200 to receive, process, and output data. Examples include the client application 108, the server applications 110 and 118, the product application 122 and the aggregator application 124. Instructions and data can be stored on non-transitory computer readable medium accessible to system 1200. For example, instructions and data may be stored on non-transitory memory 1210. Instructions and data may be transmitted to/received by system 1200 via a data signal in a transmission channel enabled (for example) by a wired or wireless network connection over interface such as 1212.

Applications accessible to system 1200 will typically include an operating system application such as Microsoft Windows®, Apple OSX, Apple IOS, Android, Unix, or Linux.

In some cases, part or all of a given computer-implemented method will be performed by system 1200 itself, while in other cases processing may be performed by other devices in data communication with system 1200.

In various embodiments, a method performed at an issue tracking system includes at least a selection, up to all of the processes:
maintaining, in data storage readable by a first computer processing system, data entities defining a plurality of issues for an issue tracking system, comprising at least one first data entity defining information for a first issue and at least one second data entity defining information for a second issue, different to the first issue;
receiving, at the first computer processing system, a first request for the first issue and in response to the first request causing display by the issue tracking system of a first user interface for the first issue, comprising display of:
   at least one display screen comprising first information defined by the at least one first data entity for the first issue;
   at least one selectable link request indicia;
   responsive to selection of a said link request indicia, one or more user interface elements for receiving link request information;
receiving at the first computer processing system link request information for material accessible by a second computer processing system, different to the first computer processing system, the link request information comprising at least one identifier of the second computer processing system and the material;
updating, by the first computer processing system, the at least one first data entity with the at least one identifier;
receiving, at the first computer processing system after said updating, a second request for the first issue and responsive to the second request:
   generating, based on the identifier, a request to the second computer processing system for the material;
   receiving the material from the second computer processing system; and
   causing display by the issue tracking system of a second user interface for the first issue, the second user interface comprising:
      at least one display screen comprising the first information defined by the at least one first data entity for the first issue and second information comprising at least a first part of the received material and a second part of the received material, different to the first part;
      at least one selectable material association indicia;
      responsive to selection of a said material association indicia, one or more user interface elements for associating at least the first part of the material with at least one displayable field of the issue;
receiving at the first computer processing system material association information requesting association of the first part of the material with a said displayable field and in response updating content of the at least one first data entity with the association;
receiving, at the first computer processing system after the updating of the at least one first data entity with the association, a third request for the first issue and responsive to the third request:
   based on the content of the at least one first data entity with the association, causing display by the issue tracking system of a third user interface for the first issue, the third user interface comprising at least one display screen comprising:
      information from the first data entity for the first issue and information based on the first part of the material, displayed to represent an association of the first part of the material to the first issue; and
      information from the second data entity for the second issue, displayed to represent an absence of association of the first part of the material to the second issue.

In some embodiments the first issue has a first issue type within the issue tracking system, associated with a first workflow, and wherein the method further comprises receiving at the first computer processing system a request to change the first issue to a second type associated with a second workflow, different to the first workflow, and in response updating the first data entity from indicating the first issue type to the second issue type and maintaining the update of the first data entity with the at least one identifier. In some embodiments the method further includes maintaining the update of the first data entity with the association of the first part of the material to the first issue.

In some embodiments the first issue type and first workflow relate to tracking ideas for projects within the issue tracking system and wherein the second issue type and second workflow relate to tracking projects within the issue tracking system.

In some embodiments the first request for the first issue is a request to display the first issue and not the second issue.

In some embodiments the second request for the first issue is a request to display the first issue and not the second issue.

In some embodiments the third request for the first issue is a request to display a plurality of issues, comprising the first issue and the second issue. The third for the first issue may be a request to display a list of issues. The third request for the first issue may be a request to display a board of issues.

In various embodiments a method performed at an issue tracking system, includes:
maintaining, in data storage readable by a first computer processing system, data entities defining a plurality of issues for an issue tracking system, comprising:
   one or more first data entities defining information for a first issue, wherein the one or more first data entities comprise:
      data defining the first issue as a first issue type within the issue tracking system, wherein the first issue type is associated with a first workflow of the issue tracking system or is not associated with a workflow of the issue tracking system; and
      at least one identifier of a second computer processing system and material accessible by the second computer processing system; and
receiving at the first computer processing system a request to change the first issue to a second issue type associated with a second workflow, different to the first workflow, and in response updating the one or more first data entities to comprise data defining the first issue as the second issue type while maintaining the at least one identifier of the second computer processing system and material accessible by the second computer processing system;
retrieve based on the at least one identifier at least part of the material accessible by the second computer processing system and cause display of information based on the retrieved material, in a user interface for the first issue when the first issue is defined as the first issue type and in a user interface for the first issue when the first issue is defined as the second issue type.

In some embodiments the issue tracking system maintains a plurality of issues comprising the first issue and a second issue, different to the first issue, and wherein the user interface for the first issue when the first issue is defined as the first issue type is a first user interface displaying the first issue and not the second issue and wherein the method further comprises causing display of a second user interface displaying the first issue and the second issue, the second user interface comprising display of said information based on the retrieved material.

In some embodiments the second user interface comprises a list and the first issue and the second issue are in the list and wherein the method further comprises sorting the list based on said information based on the retrieved material.

In some embodiments the display information based on the retrieved material in a user interface for the first issue when the first issue is defined as the first issue type and the second issue type is based on a user association of at least part of the retrieved material with a first displayable field of the issue tracking system. In some embodiments the method further includes causing display of a further user interface for the first issue, the further interface comprising a plurality of selectable displayable fields of the issue tracking system, the plurality of selectable displayable fields comprising the first displayable field, and wherein the method comprises receiving user input selecting the first displayable field and in response recording in data storage the user association of at least part of the retrieved material with the first displayable field.

Various embodiments of an issue tracking system, include a first computer processing system and data storage readable by the first computer processing system, wherein the first computer processing system is configured to:
maintain in the data storage data entities defining a plurality of issues of the issue tracking system, comprising;
   one or more first data entities defining information for a first issue, wherein the one or more first data entities comprise:
      data defining the first issue as a first issue type within the issue tracking system, wherein the first issue type is associated with a first workflow of the issue tracking system; and
      at least one identifier of a second computer processing system and material accessible by the second computer processing system; and
receive a request to change the first issue to a second issue type associated with a second workflow, different to the first workflow, and in response update the one or more first data entities to comprise data defining the first issue as the second issue type while maintaining the at least one identifier of the second computer processing system and material accessible by the second computer processing system;
retrieve based on the at least one identifier at least part of the material accessible by the second computer processing system and cause display of information based on the retrieved material, in a user interface for the first issue when the first issue is defined as the first issue type and in a user interface for the first issue when the first issue is defined as the second issue type.

In some embodiments the issue tracking system is configured to maintain a plurality of issues comprising the first issue and a second issue, different to the first issue, and wherein the user interface for the first issue when the first issue is defined as the first issue type is a first user interface displaying the first issue and not the second issue and wherein the issue tracking system is further configured to cause display of a second user interface displaying the first issue and the second issue, the second user interface comprising display of said information based on the retrieved material.

In some embodiments of the issue tracking system the second user interface includes a list and the first issue, and the second issue are in the list and wherein the issue tracking system is further configured to sort the list based on said information based on the retrieved material.

In some embodiments of the issue tracking system the display information based on the retrieved material in a user interface for the first issue when the first issue is defined as the first issue type and the second issue type is based on a user association of at least part of the retrieved material with a first displayable field of the issue tracking system. In some embodiments the issue tracking system is further configured to cause display of a further user interface for the first issue, the further interface comprising a plurality of selectable displayable fields of the issue tracking system, the plurality of selectable displayable fields comprising the first displayable field, and further configured to receive user input selecting the first displayable field and in response record in data storage the user association of at least part of the retrieved material with the first displayable field.

The processes and data communications illustrated in the figures and described above define operations in particular orders to explain various features. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations.

Unless otherwise stated, the terms “include” and “comprise” (and variations thereof such as “including,” “includes,” “comprising”, “comprises”, “comprised” and the like) are used inclusively and do not exclude further features, components, integers, steps, or elements.

Although the present disclosure uses terms “first,” “second,” etc. to describe various elements, these terms are used only to distinguish elements from one another and not in an ordinal sense.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage, or attribute that is not expressly recited in a claim should be considered as a required or essential feature. Accordingly, the specification and drawings are to be regarded in an illustrative rather than a restrictive sense.

1. A method comprising:
maintaining, in data storage readable by a first computer processing system implementing an issue tracking system, data entities defining a plurality of issues for the issue tracking system, comprising at least one first data entity defining information for a first issue and at least one second data entity defining information for a second issue, different to the first issue;
receiving, by the first computer processing system, link request information for material accessible by a second computer processing system, different to the first computer processing system, the link request information comprising at least one identifier, the at least one identifier identifying the second computer processing system and the material;
updating, by the first computer processing system, the at least one first data entity with the at least one identifier; and
after the updating, receiving by the first computer processing system a request to display a graphical user interface for the first issue and in response to the request displaying the graphical user interface for the first issue, wherein the graphical user interface includes display of at least one of the material and information based on the material.

2. The method of claim 1, wherein the received link request information is received from a second computer processing system, different to the first computer processing system.

3. The method of claim 2, wherein the second computer processing is providing a web browser and the received link request information comprises a link to a network address displayed by the web browser.

4. The method of claim 2, wherein the second computer processing is providing an application for aggregating data, the received link request information comprises a link to the application and the material is data aggregated by the application.

5. The method of claim 4, wherein the at least one identifier comprises a plurality of identifiers, including a first identifier associated with the material and a second identifier associated with different material and wherein the link request information further comprises a user selection, the user selection designating the first identifier.

6. The method of claim 5, wherein the plurality of identifiers is received by the first computer processing system responsive to a request from the first computer processing system for available link information, in accordance with an application programing interface of the application for aggregating data.

7. The method of any one of claims 1-6, wherein the first data entity and the second data entity are associated with a project and include a plurality of fields and wherein the updating of the at least one first data entity with the at least one identifier comprises including the at least one identifier in a field of the first data entity and not in a field of the second data entity.

8. The method of claim 3, wherein the first data entity and the second data entity are associated with a project and include a plurality of fields and wherein the updating of the at least one first data entity with the at least one identifier comprises including the link to a network address in a field of the first data entity and not in a field of the second data entity.

9. The method of claim 8, further comprising including the material in a field of the first data entity and not in a field of the second data entity.

10. The method of claim 1, wherein the received link request information does not include the material and wherein the method further comprises, responsive to the request to display the graphical user interface for the first issue, sending by the first computer processing system to the second processing system, a request for the material, wherein the request for the material is generated based on the at least one identifier identifying the second computer processing system and the material.

11. The method of claim 1, further comprising after the updating, receiving a user request and in response to the user request creating in the data storage at least one third data entity defining a third issue of the issue tracking system, wherein the third issue is of a different type to the first issue.

12. The method claim 11, further comprising receiving a request to display the third issue and in response to the request displaying the third issue together with the material.

13. The method of claim 1, further comprising after the updating, receiving a user request and in response to the user request creating in the data storage at least one third data entity defining a third issue of the issue tracking system, wherein the third issue is associated with a project workflow of the issue tracking system and the first issue is not associated with the project workflow.

14. The method claim 13, further comprising receiving a request to display the third issue and in response to the request displaying the third issue together with the material.

15. A method comprising:
maintaining, in data storage readable by a first computer processing system implementing an issue tracking system, data entities defining a plurality of issues for the issue tracking system, comprising at least one first data entity defining information for a first issue and at least one second data entity defining information for a second issue, different to the first issue;
receiving, by the first computer processing system, link request information for material accessible by a second computer processing system, different to the first computer processing system, the link request information comprising the material;
updating, by the first computer processing system, the at least one first data entity with the material; and
after the updating, receiving by the first computer processing system a request to display a graphical user interface for the first issue and in response to the request displaying the graphical user interface for the first issue, wherein the graphical user interface includes display of at least one of the material and information based on the material.

16. The method of claim 15, wherein the link request information is generated by a third computer processing system, the third computer processing running a web browser, the web browser including an extension or plug-in that generates the link request information and communicates it to the first computer processing system.

17. The method of claim 15, further comprising after the updating, receiving a user request and in response to the user request creating in the data storage at least one third data entity defining a third issue of the issue tracking system, wherein the third issue is of a different type to the first issue.

18. The method claim 17, further comprising receiving a request to display the third issue and in response to the request displaying the third issue together with the material.

19. The method of claim 15, further comprising after the updating, receiving a user request and in response to the user request creating in the data storage at least one third data entity defining a third issue of the issue tracking system, wherein the third issue is associated with a project workflow of the issue tracking system and the first issue is not associated with the project workflow.

20. The method claim 19, further comprising receiving a request to display the third issue and in response to the request displaying the third issue together with the material.
